(19) United States
(12) Patent Application Publication
(10) Pub. No.: US 2024/0271396 A1
(43) Pub. Date: Aug. 15, 2024

(54) METHOD AND SYSTEM FOR PRODUCING DRINKING WATER FROM AIR

(71) Applicant: WATERGEN LTD, Petach Tikva (IL)

(72) Inventors: Sharon DULBERG, Beer Sheva (IL); Omer JACOB, Tzur Hadassah (IL)

(73) Assignee: WATERGEN LTD, Petach Tikva (IL)

(21) Appl. No.: 18/682,076

(22) PCT Filed: Aug. 8, 2022
(86) PCT No.: PCT/IL2022/050866

§ 371 Date: Feb. 7, 2024

Related U.S. Application Data
(60) Provisional application No. 63/231,075, filed on Aug. 9, 2021.

(51) Int. Cl. E03B 3/28; B01D 53/26

(52) U.S. Cl. CPC E03B 3/28; B01D 53/261

(57) ABSTRACT

An apparatus and methods for extracting water from air with desiccants is disclosed. In some embodiments, the apparatus includes a reactor (i) for flowing hot dry air through a water saturated desiccant to desorb water therefrom into the hot dry air to obtain humidified hot air or (ii) for flowing an external airflow through the desiccant to obtain the water saturated desiccant. The first heat exchanger transfers heat from the humidified hot air to the cold dry air to obtain humidified cool air and warm dry air. The second heat exchanger removes excess heat from the humidified cool air toward outside of the apparatus to cool the humidified cool air, to obtain water and cold dry air. The heater produces hot dry air for flowing through the water saturated desiccant. The flow paths of hot dry air, humidified hot air, humidified cool air, and cold dry air are in a closed-loop.

The present invention generally relates to a method and system for producing water. In particular, the present invention relates to a method and system for extracting water from air with desiccants.

### BACKGROUND ART

Around the world, the existence of liquid water of any kind cannot be guaranteed. However, one can always find large quantities of water vapor in the air. Even in climates which have high temperature and low humidity, there is plentiful water in the air. The reason for this is that higher temperatures increase the saturation pressure of the water vapor (i.e., the the ability to hold more water increases).

Extraction of liquid from gas, such as extraction of water from air, is well known and typically involves enforcement of condensation conditions of gas containing liquid vapor by lowering its temperature below the dew point temperature, thereby causing vapor to condensate and liquid is thereby released from the carrying gas. While this method is highly available, there are several difficulties for making this method competitive with alternative water sources which draw their water from the regular water distribution pipelines.

One of the main challenges existing with this method is that the performance of these methods and the water generation yield decreases drastically in dry geographical regions. This is due to lower dew point temperature and water content in the ambient air. Further, in some regions, the dew point temperatures fall below the freezing point of water, which makes it very impractical to produce water using conventional air-conditioning based water-from-air systems. As such, it is increasingly difficult and expensive to produce potable water. The high energy cost, and the high cost of available systems often render this solution uneconomical. The energy cost for a given amount of extracted water, is an important factor in deciding to which solution to choose.

There is a need for an energy-efficient and cost-efficient system and method for producing water from air. There is a particular need for this kind of system and method in regions where the relative humidity is low.

Other objects, advantages and applications of the invention will be made apparent by the following description of the preferred embodiment of the invention.

### SUMMARY OF THE INVENTION

An embodiment of the present invention provides a method for producing water. The method including a first operating period and a second operating period. At the first operating period: flowing a first airflow through a desiccant to adsorb moisture from the airflow in the desiccant and obtain a water saturated desiccant. At the second operating period following the first operating period: a) flowing hot dry air through the water saturated desiccant to desorb water from the water saturated desiccant into the hot dry air to obtain humidified hot air; b) directing the humidified hot air to a first heat exchanger to transfer heat from the humidified hot air to a flow of cold dry air to obtain humidified cool air; c) introducing the humidified cool air to a second heat exchanger configured to remove excess heat from the humidified cool air to an outside environment, to further cool the humidified cool air to its dew point, to obtain water and cold dry air; and d) directing the cold dry air to the first heat exchanger to transfer heat from the humidified hot air to the cold dry air, and heat the cold dry air to obtain warm dry air. The warm dry air may be heated in a heater to produce the hot dry air for flowing through the water saturated desiccant. The flows of the hot dry air, the humidified hot air, the humidified cool air, the warm dry air, and the cold dry air during the second operating period may flow in a closed-loop pathway. In an embodiment, the method may be continuously reiterated.

In an embodiment, the desiccant in the first operating period and/or the second operating period may be a solid desiccant. In a further embodiment, the water saturated desiccant may be positioned in a fluidized bed reactor. In a further embodiment, the water saturated desiccant may be positioned in a desiccant wheel. The heater may be a non-electric heater. In a specific example, the heater may be a solar heater or a waste heat recovery unit.

According to an embodiment, the method may include a first transient period prior to the second operating period and comprising circulating air through the water saturated desiccant and the heater during said first transient period. Excess pressure created in the first transient period may be reduced. The method may further comprise a second transient period prior to the first operating period, wherein pressure reduction created in the second transient period may be at least partially eliminated by flowing external air into the closed-loop pathway.

An embodiment of the present invention provides a method for extracting water from the air. The method may include: a) flowing hot dry air through a water saturated desiccant, to desorb water from the desiccant into the hot dry air and thereby obtain humidified hot air; b) directing the humidified hot air to a first heat exchanger to cool the humidified hot air to obtain humidified cool air; c) introducing the humidified cool air to a second heat exchanger in which excess heat from the humidified cool air is removed to an external environment, to further cool the humidified cool air, thereby producing water and cold dry air; and d) directing the cold dry air to the first heat exchanger such that heat may be transferred from the humidified heated air to the cold dry air by way of the first heat exchanger, to heat the cold dry air to obtain warm dry air. The warm dry air may be heated in a heater to produce the hot dry air prior to flowing through the water saturated desiccant. The flows of the hot dry air, the humidified hot air, the humidified cool air, the warm dry air, and the cold dry air during the second operating period may flow in a closed-loop pathway.

In an embodiment, the desiccant in the first operating period and/or the second operating period may be a solid desiccant. In a further embodiment, the water saturated desiccant may be positioned in a fluidized bed reactor. In a further embodiment, the water saturated desiccant may be positioned in a desiccant wheel. The heater may be a non-electric heater. In a specific example, the heater may be a solar heater or a waste heat recovery unit. According to an embodiment, prior to the flowing of step a), air may be circulated through the water saturated desiccant and the heater. Excess pressure which may be created prior to the flowing of step a) may be reduced.

An embodiment of the present invention provides a method for producing water from air. According to the method, during a first operating period in a first reactor assembly, a) adsorbing moisture from the air into a desiccant by placing a first airflow in contact with said desiccant. In a second reactor assembly b) flowing hot dry air through a second water saturated desiccant, to desorb water from the second desiccant into the hot air and thereby obtain humidified hot air; c) directing the humidified hot air to a first heat exchanger to obtain humidified cool air; d) introducing the humidified cool air to a second heat exchanger configured to remove excess heat from the humidified cool air towards outside of the assembly, to further cool the humidified cool air to its dew point, thereby producing water and cold dry air; and e) directing the cold dry air to the first heat exchanger such that heat may be transferred from the humidified heated air to the cold dry air by way of the first heat exchanger, so as to heat the cold dry air to become warm dry air. The warm dry air may be heated in a heater to produce the hot dry air prior to flowing through the water saturated desiccant. The air in steps b) through e) may flow in a closed-loop.

The method may further include a second operating period, during which in the first reactor assembly f) flowing hot dry air through the first water saturated desiccant, to enable desorption of water from the first desiccant into the hot air and thereby obtain humidified hot air; g) directing the humidified hot air to a first heat exchanger to cool the air to humidified cool air; h) introducing the humidified cool air to a second heat exchanger configured to remove excess heat from the humidified cool air towards outside of the assembly, to further cool the humidified cool air to its dew point, thereby producing water and cold dry air; and i) directing the cold dry air to the first heat exchanger to transfer heat from the humidified heated air to the cold dry air by way of the first heat exchanger, to heat the cold dry air to obtain warm dry air. The warm dry air may be heated in a heater to produce the hot dry air prior to flowing through the water saturated desiccant, the air in steps f) through i) may flow in a closed-loop. In the second reactor assembly j) saturating the second desiccant with water by placing a first airflow in contact with said second desiccant. In an embodiment, the first reactor assembly and/or the second reactor assembly may include at least one fluidized bed. In a further embodiment, the first reactor assembly and/or the second reactor assembly may include at least one desiccant wheel. According to an embodiment, the desiccant in the first reactor assembly and/or the second reactor assembly may be a solid desiccant. The heater may be a non-electric heater. In a specific example, the heater may be a solar heater or a waste heat recovery unit. According to an embodiment, prior to the flowing of steps b) or f) air may be circulated through the water saturated desiccant and the heater. Excess pressure created prior to step b) or f) may be reduced. Pressure reduction created prior to step a) or step j) may be at least partially eliminated by flowing external air into the closed-loop pathway.

An embodiment of the present invention provides an apparatus for producing water including flow paths for hot dry air, humidified hot air, humidified cool air, and cold dry air in a closed-loop, a desiccant adapted to adsorb moisture from an external airflow to yield water saturated desiccant, a reactor (i) for flowing the hot dry air through the first water saturated desiccant to desorb water from the desiccant into the hot dry air to obtain the humidified hot air or (ii) for flowing the external airflow through the desiccant to obtain the water saturated desiccant, a first heat exchanger to transfer heat from the humidified hot air to the cold dry air to obtain humidified cool air and warm dry air, a second heat exchanger adapted to allow the heat to be dissipated to the environment to cool the humidified cool air to its dew point, to obtain water and cold dry air, and a heater to produce the hot dry air for flowing through the water saturated desiccant. In an embodiment, the apparatus may include multiple reactors, wherein in at least one reactor water is desorbed from the desiccant and wherein in at least one reactor moisture is adsorbed by the desiccant. The two reactors may work interchangeably, and change their function as the desiccant becomes saturated or dry. The desiccant may be a solid desiccant. In an embodiment, apparatus may include at least one fluidized bed. In a further embodiment, the apparatus may include at least one desiccant wheel. The heater may be a non-electric heater. In a specific example, the heater may be a solar heater or a waste heat recovery unit. There may be further provided a restrictor for allowing volumetric expansion or contraction of the closed-loop air pathway.

A complete understanding of the present invention will be evident from the following description of the embodiments thereof, together with the hereinbelow figures.

### BRIEF DESCRIPTION OF THE DRAWINGS

Embodiments will hereinafter be described with reference to the accompanying drawings which have not necessarily been drawn to scale. Where applicable, some features have not been illustrated in order to assist in the illustration and description of underlying features. Throughout the figures, like reference numbers denote like elements.

FIG. 1 is a simplified diagram showing an arrangement for a desiccant based atmospheric water generator (AWG), according to one or more embodiments of the invention.

FIG. 2 is a simplified diagram showing an arrangement for a desiccant based atmospheric water generator (AWG) during the first transient period, according to one or more embodiments of the invention.

FIG. 3 is a simplified diagram showing an arrangement for a desiccant based atmospheric water generator (AWG) during desorption of the desiccant, according to one or more embodiments of the invention.

FIG. 4 is a simplified diagram showing an arrangement for a desiccant based atmospheric water generator (AWG) during simultaneous adsorption and desorption of the desiccant, according to one or more embodiments of the invention.

FIG. 5 is a flow chart of a routine for operating an apparatus for producing water.

FIG. 6 is a simplified diagram showing an arrangement for a desiccant based atmospheric water generator (AWG), including a heating system, according to one or more embodiments of the invention.

FIG. 7 is a simplified diagram showing an arrangement for a desiccant based atmospheric water generator (AWG), including a thermal storage system, according to one or more embodiments of the invention.

### DETAILED DESCRIPTION OF THE INVENTION

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

The terms used herein is for the purpose of description and should not be viewed as limiting. The use of “including,” “comprising,” “having,” “containing,” “involving,” and variations thereof herein, is meant to encompass the items listed thereafter and equivalents thereof, as well as additional items.

The terms “optional” or “optionally” means that the described component may or may not be present, or that the described step in a process may or may not occur, and that the description includes instances where the component is present or the step does occur, and instances where the component is not present or the step does not occur.

The term “a” or “an” as used herein includes the singular and the plural, unless specifically stated otherwise. Therefore, the terms “a,” “an” or “at least one” can be used interchangeably in this application.

As used herein, “about” refers to a numeric value, including, for example, whole numbers, fractions, and percentages. The term “about” generally refers to a range of numerical that one of ordinary skill in the art would consider equivalent to the recited value (i.e. having the same function or result). In this regard, use of the term “about” herein specifically includes ±10% from the indicated values in the range. In some instances, the term “about” may include numerical values that are rounded to the nearest significant figure.

As used herein, the term “adsorption” may be defined as a process that defines the transfer of a molecule from a fluid to a solid surface. In a particular embodiment, adsorption refers to the transfer of moisture from an air flow to a desiccant material.

As used herein, the term “desorption” may be defined as the process of expelling and repulsing moisture. In a particular embodiment, desorption refers to the transfer of moisture from a desiccant material to an air flow.

As used herein, the term “desiccant” refers to any material such as a liquid, solid or gas material that has the ability to adsorb moisture under specific conditions (e.g. humidity, pressure and temperature) and the ability to desorb moisture under specific conditions (e.g. humidity, pressure and temperature).

As used herein, the inlets of the various parts of the system refer to the parts where the air flow enters. As used herein, the outlets of the various parts of the system refer to the parts where the air flow exits.

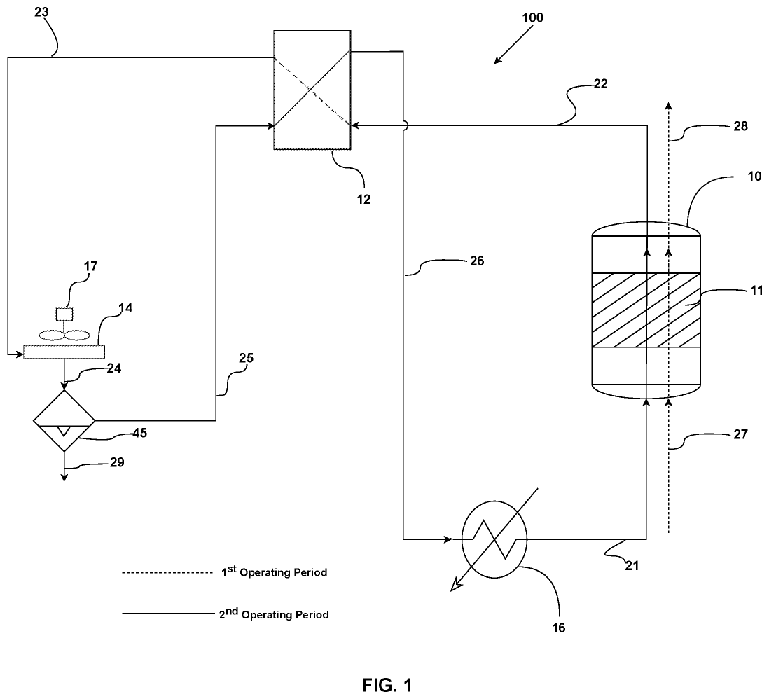

Although FIGS. 1-4 depict the air flow to be in straight lines, this configuration is not a requirement for the functioning of the water generation system. The system may also have the air flow at any angle and/or oriented in any direction.

Embodiments of the present invention that are described herein provide improved methods and systems for extracting water from air. The embodiments described herein refer mainly to the use of desiccants for extracting water from the air, but the disclosed techniques can be used in various other suitable applications that involve removing water from air.

In some embodiments, a reactor comprises a water saturated desiccant. A closed-loop pathway provides for hot dry air to be humidified by being placed in contact with the water saturated desiccant. As may be understood, the hot dry air may contact the desiccant as it flows through the reactor. The humidified hot air in the closed-loop pathway is cooled in a first heat exchanger to produce humidified cool air and a heat sink to lower the temperature of the air to below its dewpoint and produce cold dry air. The cooling operation causes at least part of the moisture to condensate, and thus dries the humidified hot air. The cool dry air in the closed-loop pathway is reheated in a heating element, and the reheated air is reintroduced into the reactor. It may be understood by one skilled in the art that any suitable motivation device, (e.g. a fan) may be used to enable the air to flow within the closed loop.

In order to improve the energy efficiency of the water producing system, a first heat exchanger is inserted in the closed-loop air pathway. The heat exchanger exchanges heat between the humidified hot air which may be humidified by being placed in contact with a water saturated desiccant and the cold dry air cooled by the heat sink prior to reheating. The humidified cool air exiting the first heat exchanger is further cooled by the heat sink thereby causing condensation of water therefrom, and the cold dry air that exits the heat sink is heated by the humidified hot air in the first heat exchanger.

By performing the above-described heat exchange operation inside the closed-loop air pathway, a considerable portion of heat energy, which has been removed from the air and from the condensing water vapor, is reused and fed-back into the water saturated desiccant. Consequently, the energy efficiency of the system improves considerably.

The disclosed solution can be viewed as a closed-loop scheme having two heat exchange operations. The first as a heat exchanger and the second as a heat sink. In the present context, the term “first heat exchanger inserted in the closed-loop pathway” means that the heat exchanger performs heat exchanging between the air flowing from two different locations along the closed-loop pathway having different thermodynamic states—the humidified hot air, and the cold dry air which has been cooled by the heat sink. The heat sink rejects heat from the airflow inside the apparatus into the outside ambient air, allowing it to cool.

Embodiments of the present invention that are described herein provide improved methods and systems for producing water from air.

FIG. 1 is a simplified diagram showing an arrangement for a desiccant based atmospheric water generator (AWG) 100, according to one or more embodiments of the invention. FIG. 1 provides an apparatus for producing water 100 which includes a reactor 10, a first heat exchanger 12, a heat sink 14, water-air separator 45, conduits 21, 22, 23, 24, 25, 26 and a heater 16. A desiccant 11 which is adapted to adsorb moisture from an external air flow 27 is positioned within reactor 10. As external air flow 27 flows through reactor 10 it is exposed to desiccant 11.

According to embodiments of the invention, the desiccant may be defined as any material capable of extracting water molecules from an airflow under certain specific conditions, such as for example humidity, pressure and temperature of the airflow and capable of releasing the water molecules accumulated therein under certain conditions, such as for example humidity, pressure and temperature. The desiccant may be a solid desiccant or a liquid desiccant. Examples of solid desiccants include but are not limited to silica gel, zeolites such as aluminum-rich zeolites, polymeric desiccants such sodium polyacrylates, metal-organic frameworks, montmorillonite clay, activated charcoal, phosphorus pentoxide, barium oxide, aluminum oxide, sodium hydroxide, potassium hydroxide, calcium chloride, calcium bromide, calcium sulfate and zinc chloride. Examples of liquid desiccants include but are not limited to lithium chloride, lithium bromide, calcium chloride, magnesium chloride, and polyols such as ethylene glycol, propylene glycol, butylene glycol, pentylene glycol, glycerol, trimethyol propane, diethytlene glycol, triethylene glycol, tetraethylene glycol, dipropylene glycol, tripropylene glycol, tetrapropylene glycol, and mixtures thereof. In some embodiments, the desiccant is a food-grade desiccant such as food grade silica gel.

Reactor 10 may comprise a fluidized bed reactor, wherein a solid desiccant undergoes fluidization. The solid desiccant may be for example in the form of an adsorbent powder, beads, pellets, capsules or agglomerates. In a fluidized-bed reactor, a fluid such as air flows continuously through the reactor containing solid particulates. Under specific conditions as known in the art, this will cause the solid particulates to become fluidized. In an embodiment, fluidization of the desiccant may be enabled by a specific geometry of the reactor and/or electro-mechanical components such as for example an air displacement device.

In an embodiment, mesh filters may be placed in reactor 100 such that desiccant 11 remains in the reactor and cannot escape through airflows 21, 22, 27 or 28. The mesh filters may be designed on one hand to allow the air flows to pass through but on the other hand to prevent the desiccant from escaping. In yet another embodiment, the internal shape of the reactor may be designed to create vortices and allow fluidization of the airflows in the closed-loop pathway. In another embodiment, a blower may be located inside the reactor, so as to create vortices and allow fluidization of the airflows in the closed-loop pathway. In yet a further embodiment, the blower comprising rotating blades is located inside the reactor and may be designed such that the desiccant is pulled towards the blades, thereby reducing the size of the desiccant.

In certain embodiments, reactor 10 may comprise at least one desiccant wheel. Desiccant wheels work by directing air through a wheel which contains a solid desiccant. According to some embodiments, reactor 10 may contain multiple desiccant wheels in series or alternatively multiple desiccant wheels parallel to each other. The desiccant wheel used in the present invention, may be stationary and not rotate as it is commonly used. According to embodiments of the invention, reactor 10 may comprise a combination of at least one fluidized-bed reactor and at least one desiccant wheel. In some embodiments, a desiccant wheel in not used in conjunction with the present invention.

In the example of FIG. 1, during the first operating period, following the flow path indicated as a dashed line, external air flow 27 flows through reactor 10. Vaporized water in the air stream is adsorbed by desiccant 11 thereby obtaining a water saturated desiccant. As the air flow comes into contact with desiccant 11, the desiccant removes water vapor from the air flow 27 and the air exits the reactor as dry air stream 28. The first operation period may continue until the desiccant can no longer adsorb water from the external air. This may be determined by comparing the humidity ratio of the external ambient air flow flowing into the reactor i.e. the desiccant to the same airflow after it has come in contact with the desiccant. As described hereinabove, the amount of water that can be adsorbed by the desiccant is dependent on the ambient conditions (i.e. temperature, humidity and pressure).

According to some embodiments, the first operating period may be during nighttime hours. In some geographic regions, the temperature at night is colder and the relative humidity is higher when compared to the daytime.

In a second operating period, water is produced from the water desorbed from the desiccant by using a closed-loop pathway. The term “closed-loop” means that hot dry air is introduced into reactor 10, flowed through the water saturated desiccant, dehumidified and then reintroduced into the reactor in order to desorb further water from the desiccant. In other words, a closed-loop cycle generally does not introduce air from outside the apparatus and does not extract air from the apparatus. In some embodiments, a small quantity of air may be released from the closed-loop or added to the closed-loop, e.g., through a suitable restrictor or nozzle, whose function will be explained below. This mechanism is not regarded as violating the closed-loop cycle. Moreover, air leakage to or from the closed-cycle elements, which is common in any practical closed-cycle implementation, is also not considered violating the closed-loop cycle.

In the example of FIG. 1, during the second operating period, in the closed-loop pathway indicated as a solid line, hot dry air flows through flow path 21 and enters reactor 10 wherein it flows through the water saturated desiccant which was obtained in the first operating period. As the hot dry air flows through reactor 10, water is desorbed from the desiccant 11. By flowing hot dry air through desiccant 11, the temperature of the desiccant increases, thereby increasing its ability to desorb water which is held within the desiccant. As the water is desorbed from desiccant 11, it becomes absorbed by the hot air. The resulting humidified hot air flows from reactor 10 in flow path 22. The humidified hot air in flow path 22 passes through first heat exchanger 12. The air in flow path 23 is cooler and has a higher relative humidity than the humidified hot air flowing in flow path 22 before it enters heat exchanger 12.

As used herein, a heat exchanger refers to a device used to transfer heat between two or more fluids, for example air. In some examples of heat exchangers, the fluids may be separated to prevent mixing. Exemplary heat exchangers may include, but are not limited to, shell and tube heat exchangers, plate heat exchangers, plate and shell heat exchangers, adiabatic wheel heat exchangers, plate fin heat exchangers, pillow plate heat exchangers, pipe coil heat exchangers, fluid heat exchangers, waste heat recovery units, dynamic scraped surface heat exchangers, phase-change heat exchangers, direct contact heat exchangers, and microchannel heat exchangers.

The humidified cool air flowing in flow path 23 flows from heat exchanger 12 to heat sink 14. Heat sink 14 may be a second heat exchanger which is configured to remove excess heat from the humidified cool air to an outside environment. Heat sink 14 may be adapted to dissipate heat to an outside environment. For example, the heat sink may be an air heat exchanger, a liquid heat exchanger, plate heat exchanger, a shell and tube heat exchanger or any suitable heat exchanger that is known in the art. The heat sink may cool the humidified cool air in flow path 23 to its dew point by exchanging heat with external air. The air in flow path 23 entering heat sink 14 cools and condensates in heat sink 14, thus producing condensate water 15 while the external air is heated. The air exiting heat sink in flow path 25 is the coldest and has the lowest humidity ratio in the closed-loop pathway. In specific embodiments, a blower (not shown) may force external air over heat sink 14 in order to move air from heat sink 14 to the external environment. In an embodiment, the heat sink is a heat exchanger which is configured to remove excess heat from the humidified cool air to an outside environment with the proviso that cooling systems which is a coolant or refrigerant are excluded.

In an embodiment, a mixture of condensed water and cooled air may flow from heat sink 14 via flow path 24 to water-air separator 45. Water-air separator 45 is configured to remove the condensed water from the air flowing in the closed-loop while not allowing the air to escape from the closed-loop. Water-air separator 45 may be filled with water in its lower portion, thereby not allowing the cooled air to escape the closed-loop. The cold dry air exiting water-air separator 45 will then flow in flow path 25 to first heat exchanger 12. After separation, water may flow in flow path 29, and the cold dry air flows in flow path 25 towards first heat exchanger 12. Water-air separator 45 may be a water collector, which allows for the collection of water after it has been separated from the air. Further embodiments, may further include a sump (not shown) to store the condensed water.

The cold dry air in flow path 25 enters first heat exchanger 12 and flows against the humidified hot air in flow path 22. Heat exchanger 12 has two effects: 1) the air in flow path 23 exiting heat exchanger 12 is cooler and has a higher relative humidity than the air in flow path 22 that enters the heat exchanger; and 2) the air in flow path 26 exiting heat exchanger 12 is hotter than the air in flow path 25 that enters the heat exchanger.

To conclude the closed-loop process, warm dry air flowing in flow path 26 air is further heated by a heater 16, so as to produce hot dry air flowing in flow path 21, and the hot dry air may be reintroduced into reactor 10. Heater 16 may be any electrical or non-electrical heater. In an embodiment, the heater is a non-electrical, such as for example a solar heater. In another embodiment, the heater may be a waste heat recovery unit. A waste heat recovery unit transfers waste heat from external processes such as electricity generation, hot flue gases, or steam from cooling towers to the apparatus of the present invention. In another embodiment the system may comprise both an electric heater as well as a solar heater. The solar heater may be used when there is sufficient solar radiation and the electric heater may be used when solar radiation is not available.

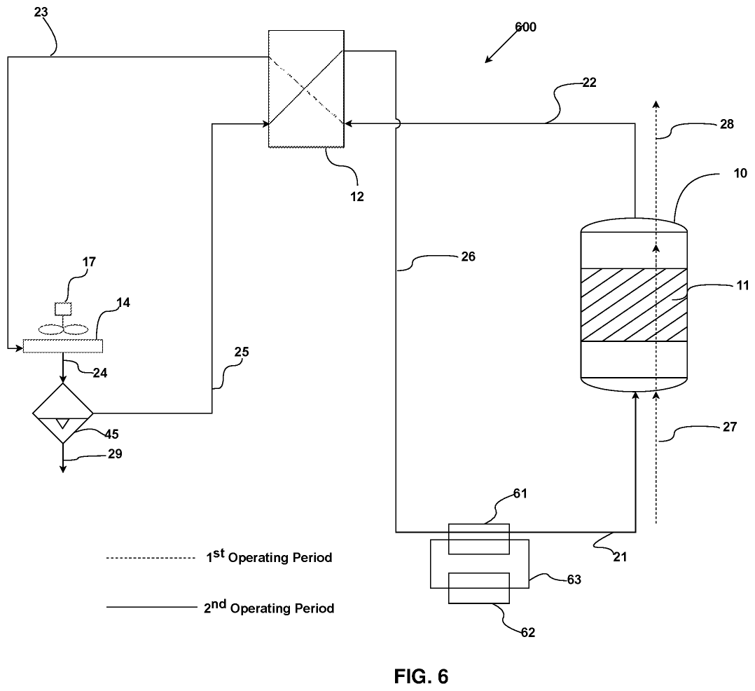

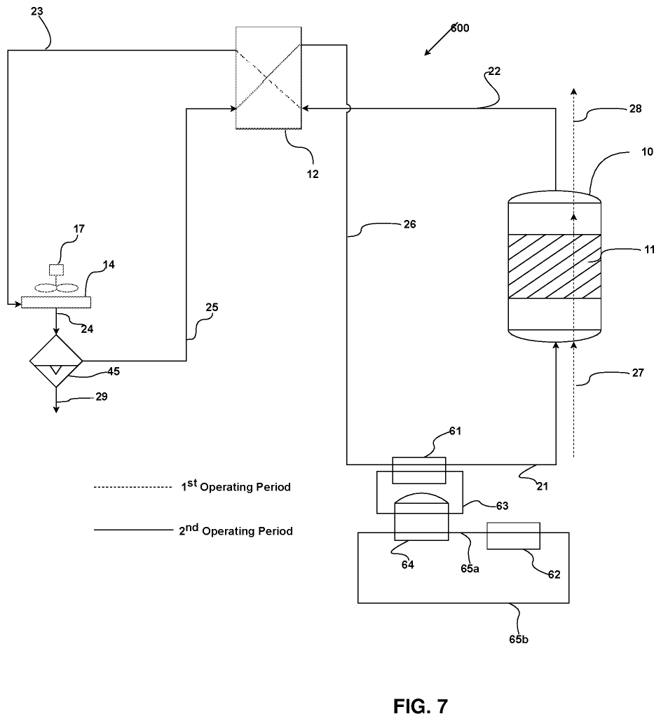

In a specific embodiment, the air in the closed-loop system may be heated by a heater as shown in FIGS. 6 and 7. With reference to FIG. 6, warm dry air flowing in flow path 26 is further heated by flowing through heat exchanger 61, which is in thermal communication with heater 62. Heater 62 may be for example a solar air heater which has any suitable fluid, such as for example air, water etc., flowing therethrough. Phase change materials are isothermal in nature, and thus offer higher density energy storage and the ability to operate in a variable range of temperature conditions. Example of phase change materials include but are not limited to paraffin, fatty acids, salt hydrates, metallics, eutectics, polymerics, organo-metallics and organics. In an embodiment, heat exchanger 61 comprises the phase change materials. Heated fluid flowing from heater 62 from heat exchanger 61 via conduit 63 transfers thermal energy to the phase change material in heat exchanger 61. The phase change material, may then transfer thermal energy stored therein to the warm dry air flowing in flow path 26. Thermal energy stored in the phase change material may used to heat the air during periods of reduced solar irradiation or during nighttime operation. This allows operation of the apparatus, during periods when solar energy is unavailable. Additionally, this would provide a constant temperature heat reservoir, which poses a challenge for all off-grid devices.

With reference to FIG. 7, the thermal storage vessel 64 can store thermal energy in the phase change material, which can transfer heat to the dry cooled air flowing through heat exchanger 61. In a non-limiting example, during the nighttime (i.e. times of reduced solar irradiation), ambient conditions are favorable for operation of the apparatus of the present invention. During nighttime, thermal energy stored in the phase change material can be transferred to the air in the closed-loop by flowing the phase change material from storage vessel 64 through heat exchanger 61 via conduit 63. Alternatively, any other suitable fluid may flow in a closed-loop, wherein its temperature is increased as it passes through the phase change material in storage vessel 64 and it transfers the thermal energy to the dry cooled air as it passes through heat exchanger 61. During the daytime (i.e. times of increased irradiation), the phase change material in storage vessel 64 can be heated by flowing a suitable fluid such as air or water via conduit 65a from heater 62, or by other heating means (e.g., solar, electrical, or fossil fuel based), so as to store thermal energy in the thermal storage vessel for later use. After heating the phase change material, the fluid may return to heater 62 via conduit 65b. In a specific embodiment, the phase change material may be heated in heater 62 and flow between thermal storage vessel 64 and heater 62 via conduits 65a and 65b.

The closed-loop process in the second operating period may be reiterated until no more water can be desorbed from the desiccant. In some embodiments, the closed-loop process may be stopped at any time. For example, the process may continuously flow as long as it is advantageous to continue desorbing water from the desiccant. The advantageousness may be based on a variety factors, including, but not limited to, the temperature and humidity of the outside air.

According to an embodiment, the process as described hereinabove with regards to FIG. 1, may be continuously reiterated. As used herein, the term “continuously reiterated” refers to twenty-four hours per day operations in both daytime hours of operation when the outside temperature is highest as well as night-time hours of operation when the temperature is colder and the relative humidity is higher when compared to the daytime. In an embodiment, after the first operating period, wherein the desiccant is sufficiently adsorbed with water such that no more water can be adsorbed by the desiccant or alternatively it is no longer advantageous for the desiccant to adsorb water, it may be desirable to proceed with the second operating period to desorb water from the desiccant. After it is no longer desirable to desorb water from the desiccant in the second operating period, the first operating period may be restarted.

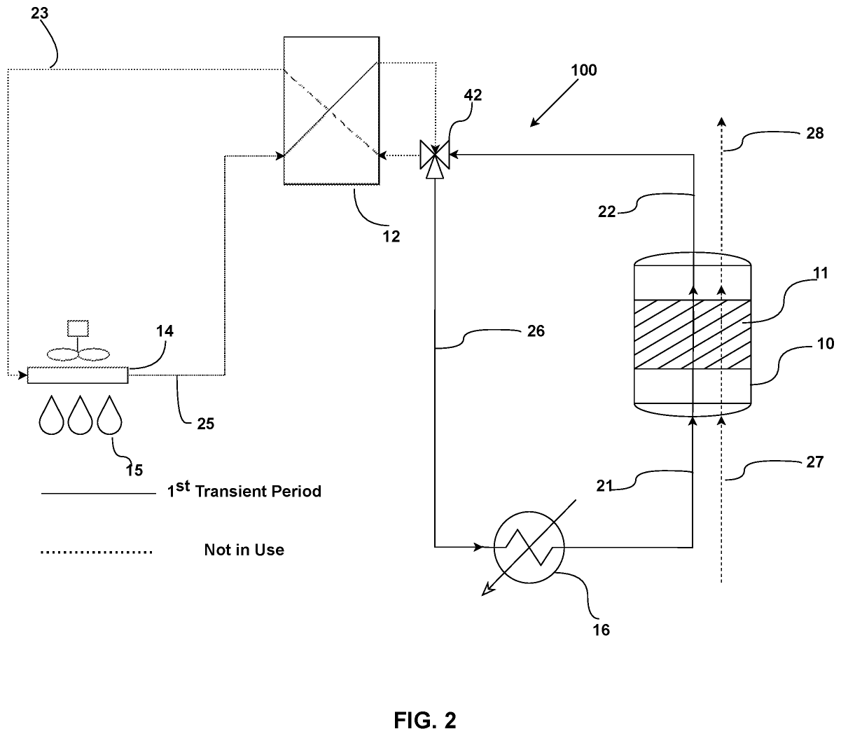

In some embodiments, a first transient period may be provided before the second operating period. As shown in FIG. 2, in order to increase the temperature of the desiccant to a temperature at which it is able to desorb water which is held within the desiccant, the closed-loop pathway may be modified such that air in the closed-loop pathway is circulated through the heater 16 and desiccant 11 which is in reactor 10, as shown as a solid line. In this manner, the heat may remain within the closed-loop system without any of the heat being lost. The first transient period may continue until the air in the closed system reaches a temperature which is hot enough for the water to desorb from the desiccant. For example, the first transient period may continue until the air in the closed-loop reaches at least 50° C., or at least 60° C., or at least 70° C., or at least 80° C. In an embodiment, the first transient period may continue until the air in the closed-loop system is sufficiently hot and humid such that it has the ability to be condensed, i.e. reaching a temperature below the dew point, after flowing through the heat sink which is configured to remove the heat from the air towards the outside ambient environment. The temperature and the humidity of the air flow in the closed-loop may be measured by any sensor or meter commonly used in the art. As ambient air temperature is dynamic and changes throughout the day, the first transient period may be long, short, or non-existent. In some embodiments, there is no need for the first transient period and water harvesting may commence after a single pass of the closed-loop air flow through the desiccant. When the first transient period is necessary to produce water, the duration of the first transient period may vary as a function of ambient conditions (e.g. ambient temperature and humidity) and the type of desiccant used.

In a specific embodiment, a three-way valve 42 may be position in the closed-loop pathway between reactor 10 and first heat exchanger 12. The valve may control the flow of air in the closed-loop pathway such that during the second operating period the air in the closed-loop pathway may flow from reactor 10 to first heat exchanger 12 and during the first transient period the air in the closed-loop pathway may flow from reactor 10 to heater 16.

In a specific embodiment, the first operating period and the first transient period may operate intermittently. As mentioned hereinabove, during the first operating period, external airflow 27 comprising vaporized water flows through reactor 10, wherein it comes into contact with desiccant 11. The desiccant removes water vapor from the air flow 27 and the air exits the reactor to the environment, as dry air stream 28. Once the desiccant becomes sufficiently saturated with water, the first transient period may start. For example, the desiccant is sufficiently saturated with water, when it is between 5%-100% saturated with water. As such time, flows 27 and 28 are stopped, and the operation of the first transient period may proceed, as described hereinabove. The first transient period may continue until sufficient water is desorbed from the desiccant. For example, during the first transient period, 5%-100% of the water may be desorbed from the desiccant. If it is determined that the air in the closed-loop pathway does not comprise sufficient water to harvest the water therefrom, the first operating period may be restarted so as to reobtain water saturated desiccant. The process may continuously switch between the first operating period and the first transient period until the air in the closed-loop pathway is sufficiently saturated with water so that water may be harvested therefrom. This determination may be made based on operational conditions such as relative humidity, humidity ratio, temperature and pressure.

Valves may be used in order to direct flow through the different parts of the closed-loop pathway. For example, valves may be used during the first transient period, such that the air initially flows through the heater and the reactor and not through the first heat exchanger and the heat sink. As used herein, a valve may be defined as a device that regulates, directs or controls the flow of a fluid by opening, closing or partially obstructing various passageways. In an open valve, fluid flows in a direction from higher pressure to lower pressure. Valves vary widely in form, size and application. Valves are quite diverse and may be classified into a number of basic types including, but not limited to hydraulic, pneumatic, manual, solenoid and motor.

In some embodiments, the apparatus may further include a restrictor in order to control the pressure in the closed-loop cycle. The restrictor enables small volumetric changes of air in the closed-loop cycle. For example, in the first transient period, when the closed-loop air volume expands due to heating and/or other process which may occur in the apparatus, the excess cold and dry air can be released from the closed cycle via the restrictor to an outside environment (i.e. external to the apparatus). By venting some of the air in the close-loop pathway, the excess pressure may be reduced. As another example, when the closed-loop air volume contracts due to cooling and/or other process which may occur in the apparatus, air from the outside environment can be added to the closed-loop via the restrictor, to compensate for the contracted volume. The pressure in the closed-loop pathway may be reduced (i.e. the air volume pressure in the closed-loop pathway may contract) during the second transient period. This pressure reduction may be at least partially eliminated by flowing external air into the closed-loop pathway.

In some embodiments, one side of the restrictor may be placed at any suitable location in the closed-loop pathway, and the other side of the restrictor may be placed at any suitable location in the outside environment.

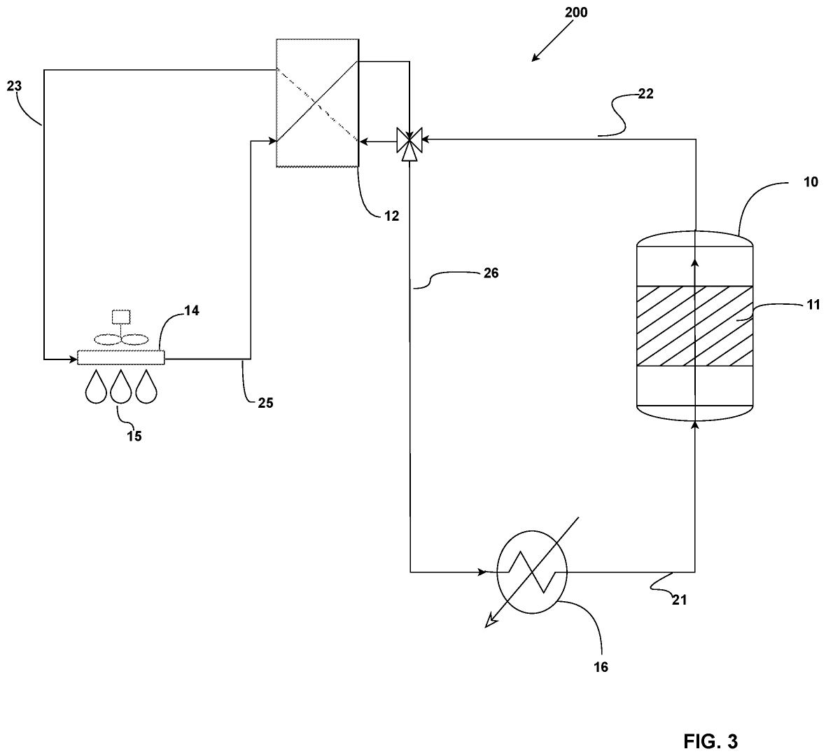

In an embodiment, the present invention provides a method for extracting water from air. Referring FIG. 3, an apparatus 200 may be provided to desorb water from desiccant 11. In the example of FIG. 3, hot dry air flows through flow path 21 and enters reactor 10 wherein it flows through water saturated desiccant 11. As the hot dry air flows through reactor 10, water is desorbed from the desiccant 11. Due to diffusion, the water is desorbed from desiccant 11, and becomes absorbed by the hot air. The resulting humidified hot air flows from reactor 10 in flow path 22. The humidified hot air in flow path 22 passes through first heat exchanger 12. The air in flow path 23 is cooler and has a higher relative humidity than the humidified hot air flowing in flow path 22 before it enters heat exchanger 12. The humidified cool air flowing in flow path 23 flows from heat exchanger 12 to heat sink 14. As described hereinabove, heat sink 14 may be a second heat exchanger which is configured to remove excess heat from the humidified cool air to an outside environment. Heat sink 14 may be adapted to dissipate heat to an outside environment. The heat sink may cool the humidified cool air in flow path 23 to its dew point by exchanging heat with external air. The air in flow path 23 entering heat sink 14 cools and condensates in heat sink 14, thus producing condensate water 15 while the external air is heated. The air exiting heat sink in flow path 25 is the coldest and has the lowest humidity ratio in the closed-loop pathway. In specific embodiments, an air displacement device such as for example a blower or a fan 17 may force external air over heat sink 14 in order to move air from heat sink 14 to the external environment. The cold dry air in flow path 25 enters first heat exchanger 12 and flows against the humidified hot air in flow path 22. As described above, heat exchanger 12 has two effects: 1) the air in flow path 23 exiting heat exchanger 12 is cooler and has a higher relative humidity than the air in flow path 22 that enters the heat exchanger; and 2) the air in flow path 26 exiting heat exchanger 12 is hotter than the air in flow path 25 that enters the heat exchanger. Warm dry air flowing in flow path 26 air is further heated by a heater 16, so as to produce hot dry air flowing in flow path 21, and the hot dry air may be reintroduced into reactor 10.

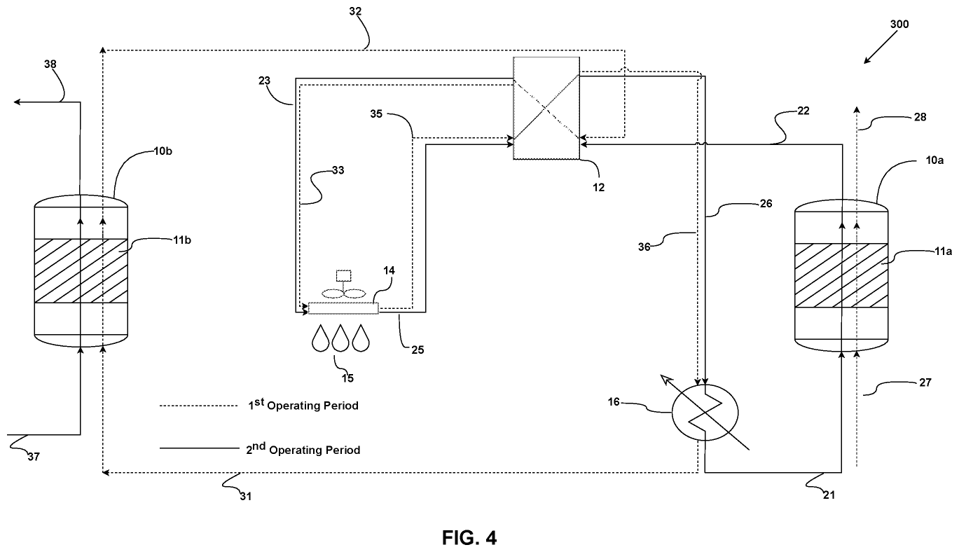

FIG. 4 is a simplified diagram showing an arrangement for a desiccant based atmospheric water generator (AWG) during simultaneous adsorption and desorption by the desiccant, according to one or more embodiments of the invention. As illustrated in FIG. 4, the water generation apparatus 300 comprises a first reactor assembly 10a and a second reactor assembly 10b. According to an embodiment, the first reactor assembly and the second reactor assembly may operate simultaneously. In one example first reactor assembly 10a comprising desiccant 11a may adsorb moisture from the air, while simultaneously second reactor assembly 10b comprising desiccant 11b may employ the closed-loop system in order to desorb water from the desiccant and produce water. In another example, second reactor assembly 10b comprising desiccant 11b may adsorb moisture from the air, while simultaneously first reactor assembly 10a comprising desiccant 11a may employ the closed-loop system in order to desorb water from the desiccant and produce water. Alternatively, both the first reactor assembly and the second reactor assembly may at the same time adsorb moisture from the air or desorb water from the desiccant and produce water. In FIG. 4, the dashed line is used to indicate the flow of air during the first operating period and the solid line is used to indicate the flow of air during the second operating period. It should be noted that although different lines are denoted for the first and second operating period in FIG. 4, this was done for the sake of clarity and one skilled in the art would understand that the same pathways may be used for each of the individual operating periods. For the sake of clarity, each of the first reactor assembly and the second reactor assembly can be used for both the adsorption and desorption actions. The system piping can be used to provide either ambient air for adsorption or closed-cycle heated air for desorption for each one of the reactors.

In some embodiments, the first reactor assembly and/or the second reactor assembly each comprise at least one reactor. For example, the first reactor assembly and/or the second reactor assembly may comprise multiple fluidized beds. In another example, the first reactor assembly and/or the second reactor assembly may comprise multiple desiccant wheels. In a further example, the first reactor assembly and/or the second reactor assembly may comprise a combination of fluidized bed and desiccant wheels.

In some embodiments, multiple reactor assemblies each comprising at least one reactor. Each reactor may individually be either adsorbing moisture from the ambient air or desorbing moisture from the desiccant. The reactors may switch from adsorption to desorption when for example the desiccant is sufficiently saturated. A multi-reactor system allows for a change in the ratio between adsorption and desorption rates in order to optimize water generation. For example, when ambient conditions are favorable towards adsorption, it may be desirable to use more reactors for desorption than for adsorption. Alternatively, when ambient conditions are favorable towards desorption, it may be desirable to use more reactors for adsorption than for desorption. As ambient conditions are constantly changing the ratio between reactors adsorbing and reactors desorbing may always change.

Referring back to FIG. 4, according to one embodiment of the present invention, during the first operating period, external airflow 27 flows through reactor assembly 10a. Vaporized water in the airflow 27 diffuses out of the air and is adsorbed by desiccant 11a thereby obtaining a water saturated desiccant. As the air flow comes into contact with desiccant 11a the desiccant removes water vapor from the air flow 27 and the air exits the reactor as dry air stream 28.

During the same operating period, water may be produced from the water desorbed from desiccant 11b using a closed-loop pathway. In the closed-loop pathway, hot dry air flows through flow path 31 and enters reactor assembly 10b wherein it flows through the water saturated desiccant 11b. As the hot dry air flows through reactor assembly 10b, water is desorbed from the desiccant 11b. By flowing hot dry air through desiccant 11b, the temperature of the desiccant increases, thereby increasing its ability to desorb water which is held within the desiccant. As the water is desorbed from desiccant 11b, it becomes absorbed by the hot air. The resulting humidified hot air flows from reactor assembly 10b in flow path 32. The humidified hot air in flow path 32 passes through first heat exchanger 12. The air in flow path 33 is cooler and has a higher relative humidity than the humidified hot air flowing in flow path 32 before it enters heat exchanger 12. The humidified cool air flowing in flow path 33 flows from heat exchanger 12 to heat sink 14. Heat sink 14 may be a second heat exchanger which is configured to remove excess heat from the humidified cool air to an outside environment. The air in flow path 33 entering heat sink 14 cools and condensates in heat sink 14, thus producing condensate water 15 while the external air is heated. As discussed hereinabove with regards to FIG. 1, the condensate water may be separated in a water-air separator which enables the removal of the water from the closed-loop while the dry cooled air is not allowed to escape the closed-loop. The air exiting heat sink in flow path 35 is the coldest and has the lowest humidity ratio in the closed-loop pathway. In specific embodiments, a blower (not shown) may force external air over heat sink 14 in order to move air from heat sink 14 to the external environment. The cold dry air in flow path 35 enters first heat exchanger 12 and flows against the humidified hot air in flow path 32. Heat exchanger 12 has two effects: 1) the air in flow path 33 exiting heat exchanger 12 is cooler and has a higher relative humidity than the air in flow path 32 that enters the heat exchanger; and 2) the air in flow path 36 exiting heat exchanger 12 is hotter than the air in flow path 35 that enters the heat exchanger. Dry air flowing in flow path 36 air is further heated by a heater 16, so as to produce hot dry air flowing in flow path 31, and the hot dry air may be reintroduced into reactor assembly 10b. As described hereinabove, heater 16 may be any electrical or non-electrical heater. In an embodiment, the heater is a non-electrical, such as for example a solar heater or a waste heat recovery unit. The first operating period may continue as long as in necessary to either adsorb sufficient water into desiccant 11a and/or desorb sufficient water from desiccant 11b.

As shown in FIG. 4, an embodiment of the present invention relates to a second operating period. The second operating period can be after the first operating period or before the first operating. The operations which take place in reactor assemblies 10a and 10b in the second operating period may be the opposite to the operations which were described with regards to the first operating period. As such, during the second operating period, second reactor assembly 10b comprising desiccant 11b may adsorb moisture from the air, while simultaneously first reactor assembly 10a comprising desiccant 11a may desorb water from the desiccant and produce water.

According to one embodiment of the present invention, during the second operating period, external airflow 37 flows through reactor assembly 10b. Vaporized water airflow 37 diffuses out of the air and is adsorbed by desiccant 11b thereby obtaining a water saturated desiccant. As the air flow comes into contact with desiccant 11b the desiccant removes water vapor from the air flow 37 and the air exits the reactor back to the outside environment as dry air stream 38.

Also, during the second operating period, water may be produced from the water desorbed from desiccant 11a using a closed-loop pathway. In the closed-loop pathway, hot dry air flows through flow path 21 and enters reactor assembly 10a wherein it flows through the water saturated desiccant 11a. As the hot dry air flows through reactor assembly 10a, water is desorbed from the desiccant 11a. As the water is desorbed from desiccant 11a, it becomes absorbed by the hot air. The resulting humidified hot air flows from reactor 10a in flow path 22. The humidified hot air in flow path 22 passes through first heat exchanger 12. The air in flow path 23 is cooler and has a higher relative humidity than the humidified hot air flowing in flow path 22 before it enters heat exchanger 12. The humidified cool air flowing in flow path 23 flows from heat exchanger 12 to heat sink 14. Heat sink 14 may be defined as hereinabove. The air in flow path 23 entering heat sink 14 cools and condensates in heat sink 14, thus producing condensate water 15 while the external air is heated. The cold dry air in flow path 25 enters first heat exchanger 12 and flows against the humidified hot air in flow path 22. As discussed above, heat exchanger 12 has two effects: 1) the air in flow path 23 exiting heat exchanger 12 is cooler and has a higher relative humidity than the air in flow path 22 that enters the heat exchanger; and 2) the air in flow path 26 exiting heat exchanger 12 is hotter than the air in flow path 25 that enters the heat exchanger. Warm dry air flowing in flow path 26 air is further heated by a heater 16, so as to produce hot dry air flowing in flow path 21, and the hot dry air may be reintroduced into reactor 10a. The second operating period may continue as long as in necessary to either adsorb sufficient water into desiccant 11b and/or desorb sufficient water from desiccant 11a.

It should be noted that the apparatus as described with regards to FIG. 4 may operate such that each of reactor assemblies 10a and 10b may individually shift between the first and second operating periods. For example, reactor assembly 10a may switch between the conditions of the first and second operating period as is necessary. The same applies to the second reactor assembly 10b. As can be envisioned by one skilled in the art, the apparatus may include additional reactor assemblies which may perform the above described processes.

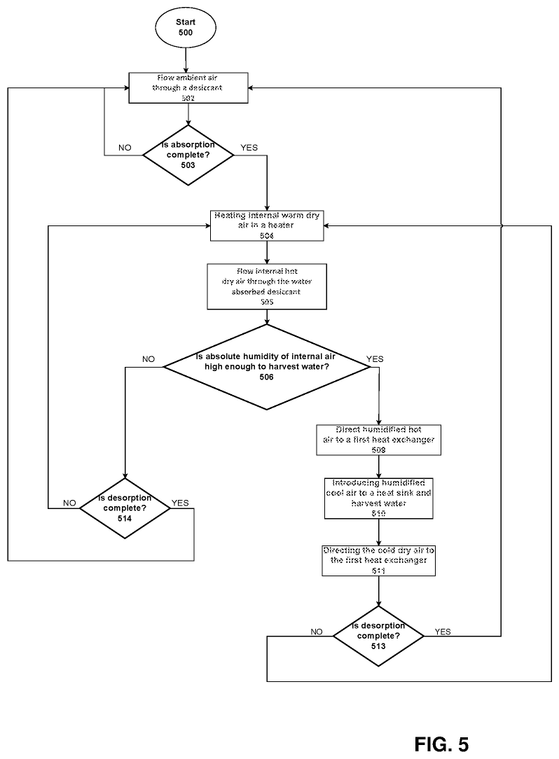

FIG. 5 is a flow chart of a routine for operating an apparatus for producing water. In step 500 operation of the apparatus is started. In step 502, the apparatus is operated in “adsorption mode” (see for example FIG. 1) and external ambient air 27 flows through desiccant 11 which may be situated in reactor 10. As the air flow comes into contact with desiccant 11, the desiccant removes water vapor from the air flow 27 and the air exits the reactor as dry air stream 28, which flows to the external environment. Continuing to step 503, if after external air flows through desiccant it is determined that the desiccant is not sufficiently saturated and adsorption is not complete, the apparatus may continue operating in “adsorption mode”. Step 502 will continue to run until the desiccant is sufficiently saturated and the adsorption is complete.

If it is determined that the adsorption is complete, it may be advantageous to operate the apparatus is “desorption mode”. “Desorption mode” may start with step 504, wherein warm dry air flowing through flow path 26 may be heated by heater 16. In step 505, the heated dry air (i.e. hot dry air) flowing in flow path 21 flow enters reactor 10 wherein it flows through the water saturated desiccant which was obtained in step 502. Continuing to step 506, if after the air in the closed-loop system flows through desiccant 11 it is determined that the absolute humidity of the air in flow path 22 (humidified hot air) is high enough to harvest water, the flow may continue to step 509, wherein it is directed to first heat exchanger 12. In some embodiments, the absolute humidity may reach high enough values that enable using ambient air as the cold temperature reservoir to condense water from the air. For example, the absolute humidity of the air may reach between 10-50 gr water vapor/kg of dry air so that water may be harvested from the air. In another example, the absolute humidity of the air may reach between 20-30 gr water vapor/kg of dry air so that water may be harvested from the air. In step, 510, the humidified cool air flowing from the first heat exchanger in flow path 23 is introduced to heat sink 14, and water 15 is harvested. In some embodiments, a mixture of condensed water and cooled air flows from heat sink 14 to water-air separator 45 wherefrom water 15 is harvested. In step 511, the cold dry air flowing from the heat sink in flow path 25 is introduced to first heat exchanger 12, wherein it flows against the humidified hot air in flow path 22 and is heated.

If it is determined in step 513 that desorption of water vapor from desiccant is not complete, the warm dry air flowing in flow path 26 is heated in heater 16 (step 504). If it is determined that the desorption in step 513 is complete, the apparatus returns to “adsorption mode”.

Returning to step 506, if after the air in the closed-loop system flows through desiccant 11 it is determined that the absolute humidity of the air in flow path 22 (humidified hot air) is not high enough to harvest water, the flow may be directed to flow path 26 and to step 504 wherein the air is heated in heater 16. It should be noted that the determination of the level of desired humidity ratio of the air in the closed-loop system is determined based on the ambient temperature. In some embodiments, the higher the ambient temperature, the higher humidity ratio of the air in the closed-loop system is required. This may occur as long as the desorption of water vapor from desiccant is not complete, as determined in step 514. However, if it is determined in step 514 that the desorption of water vapor from desiccant is complete, the apparatus returns to “absorption mode”.

One or more blowers and/or fans (not shown) can be included for flowing the air through the apparatus and specifically through the closed-loop flow path, and through the reactor. Additional flow components can also be provided, including but not limited to, valves, switches and flow rate sensors. Moreover, a controller may be provided. The controller may for example control the flow the air through the closed-loop flow path. The controller may include any combinations of mechanical or electrical components, including analog and/or digital components and/or analog and/or digital sensors and/or computer software. In particular, the controller may control the flow rate of air in the closed-loop flow path, thereby controlling for example, the rate at which water is adsorbed and/or desorbed by the air. Modifying air flow speed creates another degree of freedom for the system operation that in turn enables optimization of water production as ambient conditions changes throughout the day. The controller may also change the number of reactors performing adsorption and/or desorption at any given time in accordance with current ambient conditions, thereby optimizing water production. The controller may change patterns of control in the electro-mechanical components in accordance to the changing environment conditions as they shift during operation of the machine. The control system may include any combination of mechanical or electrical components that may be needed in order to attain its goals, including but not limited to pumps, motors, valves, circuitry (e.g. analog and digital), software (i.e. stored in volatile or non-volatile computer memory or storage), computer networks, or any other necessary component or combination of components that may be needed to attain its goals.

It will be appreciated that the modules, processes, systems, and sections described above can be implemented in hardware, hardware programmed by software, software instruction stored on a non-transitory computer readable medium or a combination of the above. A system for producing water can be implemented, for example, by using a processor configured to execute a sequence of programmed instructions stored on a non-transitory computer readable medium. The processor can include, but is not limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a non-transitory computer-readable medium such as a computer memory or storage device which can be any suitable memory apparatus, such as, but not limited to read-only memory (ROM), programmable read-only memory (PROM), electrically erasable programmable read-only memory (EEPROM), random-access memory (RAM), flash memory, disk drive, etc.

Furthermore, each of the individual components of the water producing apparatus can be implemented as a single processor or as a distributed processor. Further, it should be appreciated that the steps discussed herein can be performed on a single or distributed processor (single and/or multi-core). Further, the distribution may be implemented across multiple computers or systems or can be co-located in a single processor or system.

Embodiments of the apparatus and method, can be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, etc. In general, any process capable of implementing the functions or steps described herein can be used to implement the embodiments described herein.

Features of the disclosed embodiments can be combined, rearranged, omitted, etc., within the scope of the invention to produce additional embodiments. Furthermore, certain features can sometimes be used to achieve the desired goals without a corresponding use of other features.

It is thus apparent that there is provided in accordance with the present disclosure, apparatus, and methods for producing water from air. Many alternatives, modifications, and variations are enabled by the present disclosure. While specific embodiments have been shown and described in detail to illustrate the application of the principles of the present invention, it will be understood that alternative embodiments may be provided without departing from such principles. Accordingly, the Applicant intends to embrace all such alternatives, modifications, equivalents, and variations that are within the spirit and scope of the present invention.

1-40. (canceled)

41. An apparatus for producing water, comprising:
flow paths for hot dry air, humidified hot air, humidified cool air, and cold dry air in a closed-loop;
a desiccant adapted to adsorb moisture from an external airflow to yield a first water saturated desiccant;
a reactor comprising the desiccant (i) for flowing hot dry air through the first water saturated desiccant to desorb water from the first water saturated desiccant into the hot dry air to obtain humidified hot air or (ii) for flowing the external airflow through the desiccant to obtain the water saturated desiccant;
a first heat exchanger to transfer heat from the humidified hot air to the cold dry air to obtain humidified cool air and warm dry air;
a second heat exchanger configured to remove excess heat from the humidified cool air toward outside of the apparatus to cool the humidified cool air to its dew point, to obtain water and cold dry air; and
a heater to produce the hot dry air for flowing through the water saturated desiccant.

42. The apparatus of claim 41, comprising multiple reactors, wherein in at least one reactor water is desorbed from the desiccant and wherein in at least one reactor moisture is adsorbed by the desiccant.

43. The apparatus of claim 41, wherein the desiccant is a solid desiccant.

44. The apparatus of claim 41, wherein the reactor comprises a fluidized bed.

45. The apparatus of claim 41, wherein the reactor comprises a at least one desiccant wheel.

46. The apparatus of claim 41, wherein the heater is a non-electric heater.

47. The apparatus of claim 46, wherein the heater is a solar heater or a waste heat recovery unit.
